(19) United States
(12) Patent Application Publication
(10) Pub. No.: US 2009/0224057 A1
(43) Pub. Date: Sep. 10, 2009

(54) Battery pack for portable device in near field communication

(75) Inventors: Chien-Chow Chen, Taipei (TW); Chih-Nung Wang, Taipei (TW)

Correspondence Address: BACON & THOMAS, PLLC, 625 SLATERS LANE, FOURTH FLOOR, ALEXANDRIA, VA, 22314-1176, US

(73) Assignee: Taisys Technologies Co., Ltd., Taipei (TW)

(21) Appl. No.: 12/073,735

(22) Filed: Mar. 10, 2008

(51) Int. Cl. G06K 19/067

(52) U.S. Cl. 235/492

(57) ABSTRACT

The invention presents a battery pack for a portable device in near field communication having an integrated circuit chip for performing contactless communication, an antenna connected to the integrated circuit chip for transmitting signals between the integrated circuit chip and a remote transceiver, a power source for providing power to the portable device and the integrated circuit chip, and at least one first card holder connected to the integrated circuit chip for removably receiving at least one first integrated circuit card.

### FIELD OF THE INVENTION

The present invention relates to a battery pack, and more particularly, to a battery pack with functions of near field communication for use in a portable device.

### BACKGROUND OF THE INVENTION

Integrated Circuit Card (IC card) plays a very important role in modern life. Various IC cards are introduced to meet extensive consumer demands in hope of bringing a quicker, more convenient and secured consuming environment for consumers. IC cards have a size approximately 25 mm in length and 15 mm in width which is easy to carry. It includes a microchip for storing several tens of bytes to several tens of kilobytes of data. Since IC cards have the functions of storing data and even executing application programs, IC cards are extensively used in many areas, such as identification cards, credit cards, electronic wallets, membership cards, access cards, digital authentication cards, health care cards, telephone cards, etc. In general, an IC card is much more secured than a traditional magnetic card.

Near field communication is a short-range high frequency wireless communication technology which enables the exchange of data between devices over about a decimeter distance. The technology is a simple extension of the ISO 14443 proximity-card standard (contactless card, RFID) that combines the interface of a smart card and a reader into a single device. The applications, such as a transaction done by a magnetic prepaid card interacting with a remote card reader when a user passes gate of train station, are wildly seen. The functions of near field communication are easily performed by an antenna connected with an IC card (hereafter, smart card that is not applied in near field communication is used to distinguish from the IC cards). Such simple but convenient structures are embedded into many devices, for example, PDAs, mobile phones, etc., to provide multiple functions. However, most of current devices can not accommodate these smart cards, and new devices with smart cards are usually expensive so that they can not bring the benefits to users in a short time.

U.S. Pat. No. 5,020,136 discloses a combination of battery pack and low profile antenna arrangement in conjunction with a two-way portable transceiver. However, no smart cards are used to provide contactless transaction and data collection from a remote transceiver.

U.S. Pat. No. 6,244,894 discloses a power-source battery unit with a card mounting part to be attached detachably to a mobile phone. An IC card can be inserted into the mounting part to provide extra functions in the IC. It is shown in FIG. 1. Although the IC card functions when the battery is stowed to the mobile phone, the '894 patent is only limited to some mobile phones with same size of battery.

FIG. 2 shows an invention disclosed in U.S. Pat. No. 6,978,940. It is regarding a contactless transaction card which is detachably connectable to an antenna. The '940 patent uses a simple structure on a cover of a mobile phone to provide contactless transaction. However, without power supply from the housing, the design can not act as a stand alone card reader for requesting the information in a remote tag. It also has the disadvantage as '894 patent that the cover is only used for some models of mobile phones.

Please refer to FIG. 3. U.S. Pat. No. 7,198,199 presents a dual universal integrated circuit cards (UICC) system for a portable device. It also provides functions of near field communication. Although it is a new concept for application of near field communication, it is not applied to a battery pack.

This invention provides a suitable solution to the problems mentioned above. Since rechargeable batteries have several industrial standards, a small modification to each model of batteries causes the functions of near field communication to prevail in most portable devices. This invention uses a battery pack to have functions of near field communication for smart cards.

### SUMMARY OF THE INVENTION

This paragraph extracts and compiles some features of the present invention; other features will be disclosed in the follow-up paragraph. It is intended to cover various modifications and similar arrangements included within the spirit and scope of the appended claims, and this paragraph also is considered to refer.

In accordance with an aspect of the present invention, a battery pack for a portable device in near field communication comprises an integrated circuit chip for performing contactless communication, an antenna connected to the integrated circuit chip for transmitting signals between the integrated circuit chip and a remote transceiver, a power source for providing power to the portable device and the integrated circuit chip, and at least one first card holder connected to the integrated circuit chip for removably receiving at least one first integrated circuit card (IC card).

Preferably, the integrated circuit chip comprises an information inquiring unit for requesting the remote transceiver to send information therein via the antenna to the first IC card and a communicating unit for communication between the antenna and the first IC card.

Preferably, the battery pack comprises a switch linked to the antenna, the integrated circuit chip and the first card holder, for either electrical conduction between the antenna and the integrated circuit chip or electrical conduction between the antenna and the first IC card.

Preferably, the portable device is a mobile phone or a personal digital assistant (PDA).

Preferably, the first card holder is electrically coupled to a second card holder in the portable device for removably receiving a second IC card.

Preferably, the battery pack further comprises a dual card controller linked to the first IC card for controlling on/off status of the first IC card to provide dual card function.

Preferably, the second IC card is a subscriber identity module (SIM) card, a universal subscriber identity module (USIM) card, a removable user identity module (R-UIM) card, an Internet Protocol (IP) multimedia services identity module (ISIM) card or a smart card.

Preferably, the first IC card is a subscriber identity module (SIM) card, a universal subscriber identity module (USIM) card, a removable user identity module (R-UIM) card, an Internet Protocol (IP) multimedia services identity module (ISIM) card or a smart card.

### BRIEF DESCRIPTION OF THE DRAWING

The above objects and advantages of the present invention will become more readily apparent to those ordinarily skilled in the art after reviewing the following detailed description and accompanying drawings, in which:

FIG. 1 illustrates a conventional power-source battery unit with a card mounting part;

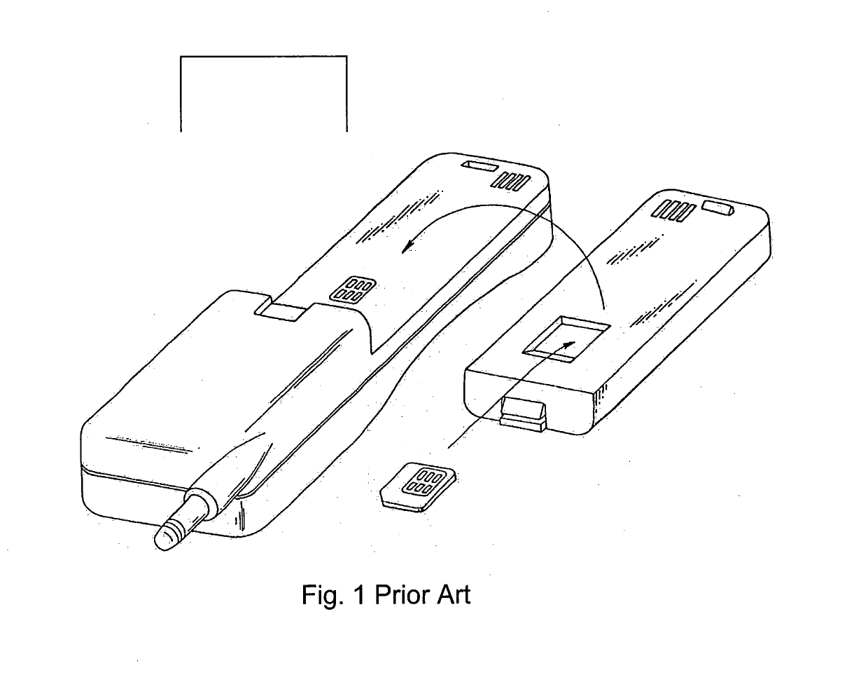

FIG. 2 illustrates a conventional contactless transaction card structure;

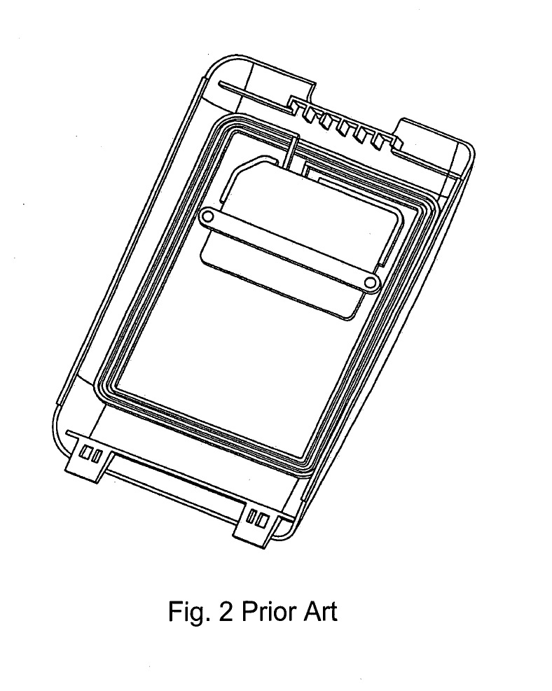

FIG. 3 illustrates a conventional dual universal integrated circuit cards (UICC) system;

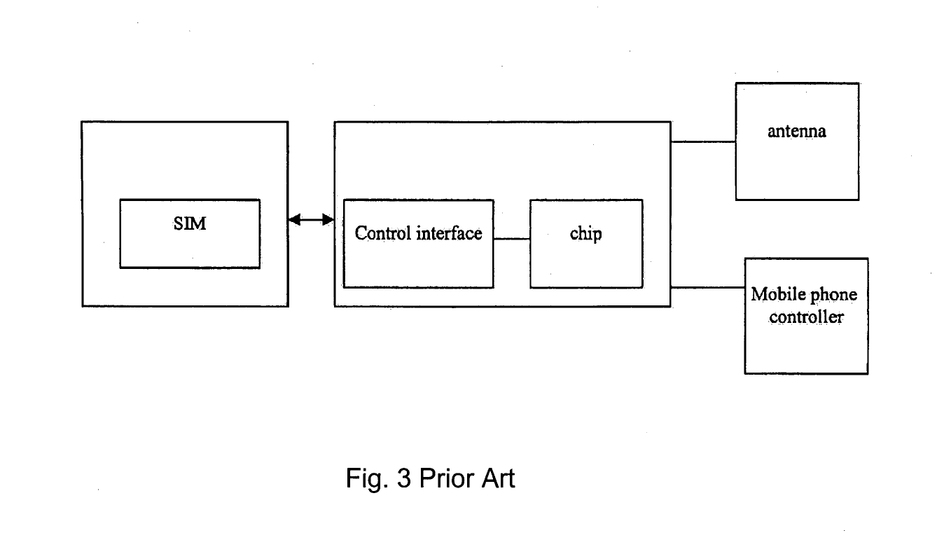

FIG. 4 illustrates a first embodiment of a battery pack for a portable device in near field communication for use in a mobile phone according to the invention; and

FIG. 5 illustrates a second embodiment of a battery pack for a portable device in near field communication according to the invention.

### DETAILED DESCRIPTION OF THE PREFERRED EMBODIMENTS

The present invention will now be described more specifically with reference to the following embodiments. It is to be noted that the following description of preferred embodiments of this invention are presented herein for purpose of illustration and description only. It is not intended to be exhaustive or to be limited to the precise form disclosed.

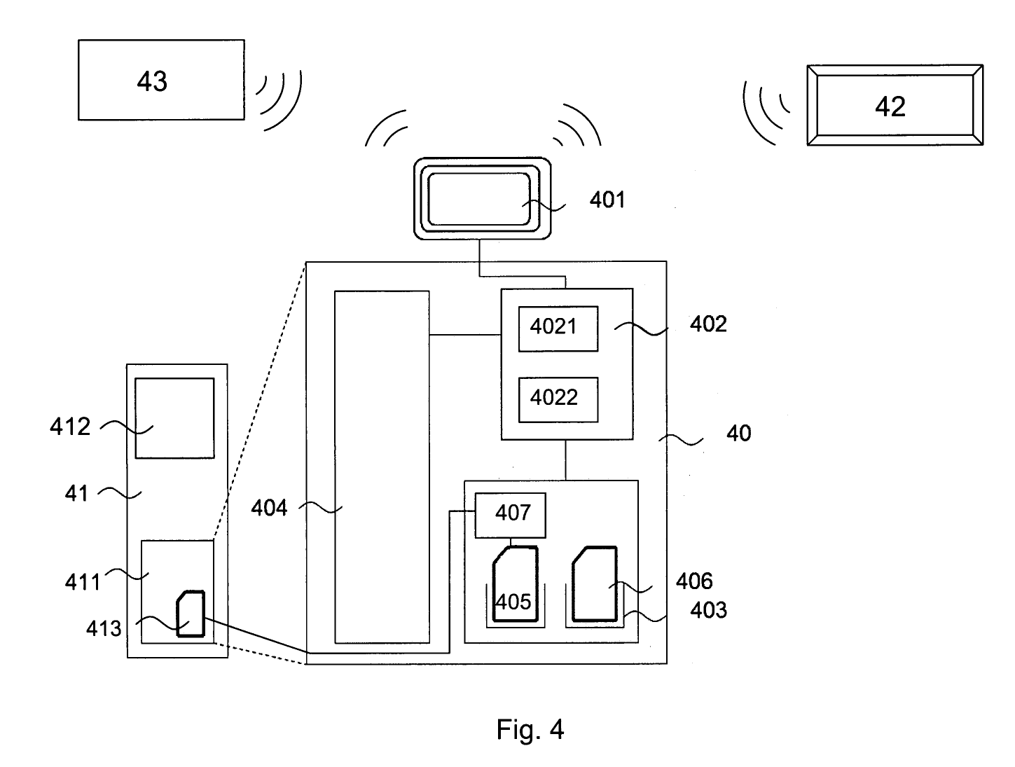

Please refer to FIG. 4. It illustrates a first embodiment of a battery pack 40 with functions of near field communication for use in a mobile phone 41. The battery pack 40 comprises an antenna 401, a near-field-communication integrated chip (NFC IC) 402, two IC card holders 403 and a rechargeable lithium ion battery module 404. The antenna 401 is provided outside of the battery pack 40 and wiredly connected to the NFC IC 402 to transmit RF signals to a remote card reader 42 or a remote tag 43. The antenna 401 also receives RF signals from the remote card reader 42 or the remote tag 43 and transmits the relevant information to the NFC IC 402. The rechargeable lithium ion battery module 404 is linked to the NFC IC 402 to provide power to the NFC IC 402. The rechargeable lithium ion battery module 404 supplies power to the mobile phone 41 as well. The IC card holders 403 are electrically connected to the NFC IC 402. The IC card holders 403 accommodate two IC cards, i.e., a Subscriber Identity Module (SIM) Card 405 and a magnetic prepaid card 406. Here the magnetic prepaid card 406 is for contactless transaction in a supermarket. The battery pack 40 is stowed in a battery holder 411 in the mobile phone 41 so that the power can be provided to the mobile phone 41 via a connector (at the back side of battery pack 40, not shown). Meanwhile, a dual card controller 407 links to the SIM card 405 in the IC card holders 403. The dual card controller 407 is further linked to another SIM card 413 in the mobile phone and provides access to other mobile phone number in the SIM card 405 than the one in the SIM card 413. The user of the mobile phone 41 can use two mobile phone numbers with only one mobile phone. The user can also check the data stored in the SIM card 405 in the IC card holder 403 via a human-machine interface, for example, a LCD panel 412 on the mobile phone.

The NFC IC 402 has information inquiring unit 4021 and communicating unit 4022. The information inquiring unit 4021 requests the remote card reader 42 or the remote tag 43 to send the relevant information via the antenna 401 to the magnetic prepaid card 406. The communicating unit 4022 keeps communication between the antenna 401 and the magnetic prepaid card 406.

On the other hand, the remote card reader 42 keeps sending RF inquiry signals to the NFC IC 402 via the antenna 401 to ask for information, such as user name and balanced credit, in the magnetic prepaid card 406. The NFC IC 402 replies the inquiry and sends the information via the antenna 401. The NFC IC 402 also sends RF inquiry signals to inquire information, such as price and date of manufacturing, in the remote tag 43 and gets the corresponding information.

In the first embodiment, the antenna 401 is assembled outside of the battery pack 41. Alternatively, the antenna 401 can be provided within the battery pack 41. The battery module 404 is not limited to lithium ion batteries. It can be any rechargeable batteries, such as nickel mental hydride batteries. Of course, with different wireless network systems, the SIM card 405 can be replaced with USIM for WCDMA, RUIM for CDMA2000, PIM for PHS, and any smart card for transaction. Besides, the battery pack 41 has functions of near field communication even if the battery pack 41 is not connected with the mobile phone 41. As long as the power is sufficient to drive the antenna 401 and the NFC IC 402, the near field communication works.

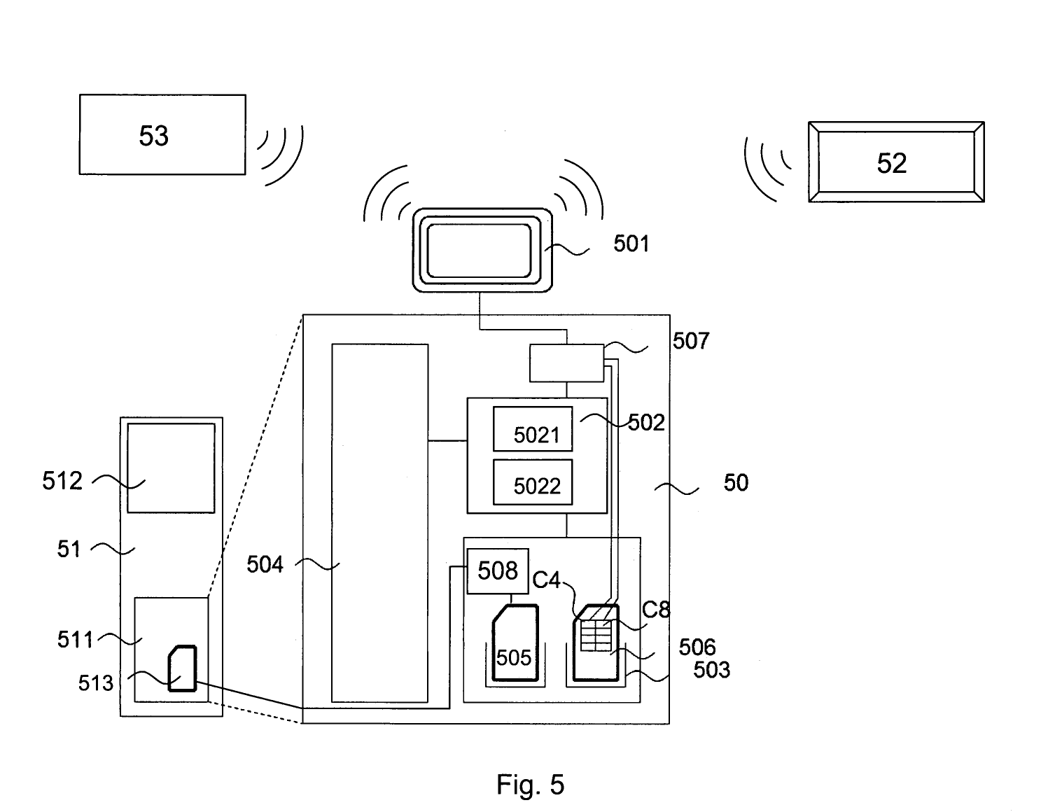

As shown in FIG. 5, a second embodiment shows a design for users to use near field communication without power source from a battery module. In the second embodiment, a battery pack 50 comprises an antenna 501, a near-field-communication integrated chip (NFC IC) 502, two IC card holders 503, a rechargeable lithium ion battery module 504 and a switch 507. The antenna 501 is assembled outside of the battery pack 50 and wiredly connected to the switch 507. The switch 507 is used for selecting different electrical conduction paths and is in turn linked to the NFC IC 502 and the IC card holders 503. If the electrical conduction between the antenna 501 and the NFC IC 502 is on, the antenna 501 transmits RF signals from the NFC IC 502 to a remote card reader 52 or a remote tag 53, receives RF signals from the remote card reader 52 or the remote tag 53 and transmits the relevant information to the NFC IC 502. The rechargeable lithium ion battery module 504 is linked to the NFC IC 502 to provide power to the NFC IC 502. The rechargeable lithium ion battery module 504 supplies power to the mobile phone 51 as well. The IC card holder 503 is electrically connected to the NFC IC 502. The IC card holders 503 accommodate two IC cards, i.e., a Subscriber Identity Module (SIM) Card 505 and a magnetic prepaid card 506. Here the magnetic prepaid card 506 is for contactless transaction in a supermarket. The switch 507 is connected with the magnetic prepaid card 506 via contacts C4 and C8 (standard) of the magnetic prepaid card 506 through the IC card holders 503. The switch 507 is not connected to the SIM card 505. The battery pack 50 is stowed in a battery holder 511 in the mobile phone 51 so that the power can be provided to the mobile phone 51 via a connector (at the back side of battery pack 50, not shown). Meanwhile, a dual card controller 508 links to the SIM card 505 in the IC card holders 503. The dual card controller 508 is further linked to a SIM card 513 in the mobile phone and provides access to other mobile phone number in the SIM card 505 than the one in the SIM card 513. The user of the mobile phone can use two mobile phone numbers with only one device. The user can also check the data stored in the SIM card in the IC card holder 503 via the interface, for example, a LCD panel 512 on the mobile phone.

The NFC IC 502 has information inquiring unit 5021 and communicating unit 5022. The information inquiring unit 5021 requests the remote card reader 52 or the remote tag 53 to send the relevant information via the antenna 501 to the magnetic prepaid card 506. The communicating unit 5022 keeps communication between the antenna 501 and the magnetic prepaid card 506.

The remote card reader 52 keeps sending the RF inquiry signals to the NFC IC 502 via the antenna 501 to ask for information, such as user name and balanced credit, in the magnetic prepaid card 506. The NFC IC 502 replies the inquiry. The NFC IC 502 also sends RF inquiry signals via the antenna 501 to request information, such as price and date of manufacturing, in the remote tag 53 and gets the corresponding information. When the electrical conduction between the antenna 501 and the IC card holder 503 is on by the switch 507, the RF inquiry signals from the antenna 501 bypass the NFC IC 502 and are transmitted to the magnetic prepaid card 506. The magnetic prepaid card 506 will reply the request from the remote card reader 52 via the antenna 501. The battery pack 50 under this situation is not able to send RF signals via the antenna 501 to request the information in the remote tag 53.

In this embodiment, the antenna 501 is assembled out side of the battery pack 50. Alternatively, the antenna 501 can be provided within the battery pack 50. The battery module 504 is not limited to lithium ion batteries. It can be any rechargeable batteries, such as nickel mental hydride batteries. Of course, with different wireless network systems, the SIM card 505 will be replaced with USIM for WCDMA, RUIM for CDMA2000, PIM for PHS, and any smart card for transaction.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are accorded with the broadest interpretation so as to encompass all such modifications and similar structures.

What is claimed is:

1. A battery pack for a portable device in near field communication, comprising:
an integrated circuit chip for performing contactless communication;
an antenna connected to the integrated circuit chip for transmitting signals between the integrated circuit chip and a remote transceiver (any spec description/drawings to support the remote transceiver?->42, 43, 52 and 53 in FIG. 4 and FIG. 5);
a power source for providing power to the portable device and the integrated circuit chip; and
at least one first card holder connected to the integrated circuit chip for removably receiving at least one first integrated circuit card.

2. The battery pack according to claim 1, wherein the integrated circuit chip comprises: (any spec description/drawings to support this claim?→has been mentioned in the spec)
an information inquiring unit for requesting the remote transceiver to send information therein via the antenna to the first integrated circuit card; and
a communicating unit for communication between the antenna and the first integrated circuit card.

3. The battery pack according to claim 1, further comprising a switch linked to the antenna, the integrated circuit chip and the first card holder, for either electrical conduction between the antenna and the integrated circuit chip or electrical conduction between the antenna and the first integrated circuit card.

4. The battery pack according to claim 1, wherein the portable device is a mobile phone or a personal digital assistant.

5. The battery pack according to claim 1, wherein the first card holder is electrically coupled to a second card holder in the portable device for removably receiving a second integrated circuit card.

6. The battery pack according to claim 5, further comprising a dual card controller (any spec description/drawings to support the dual card controller?→has been mentioned in the spec) linked to the first integrated circuit card for controlling on/off status of the first integrated circuit card to provide dual card function.

7. The battery pack according to claim 5, wherein the second integrated circuit card is a subscriber identity module card, a universal subscriber identity module card, a removable user identity module card, an Internet Protocol (IP) multimedia services identity module card or a smart card (please add description about smart card in the specification→has been mentioned in both embodiments).

8. The battery pack according to claim 1, wherein the first integrated circuit card is a subscriber identity module card, a universal subscriber identity module card, a removable user identity module card, an Internet Protocol (IP) multimedia services identity module card or a smart card (please add description about smart card in the specification→has been mentioned in both embodiments).
